(19) United States
(12) Patent Application Publication
(10) Pub. No.: US 2002/0054678 A1
(43) Pub. Date: May 9, 2002

(54) Earpiece holder

(76) Inventor: Charles Kirk Sawyer, Milford, OH (US)

Correspondence Address: CHARLES K. SAWYER, 5497 ENTERPRISE DRIVE, MILFORD, OH, 45150, US

(21) Appl. No.: 09/683,521

(22) Filed: Jan. 13, 2002

(51) Int. Cl. H04M 1/00

(52) U.S. Cl. 379/454

(57) ABSTRACT

The Earpiece Holder is a flexible holder for earpieces that are used with cellular telephones, CD players and other audio devices. Molded from a flexible material and approximately 3/4 inches wide by 1/2 inch high, the Earpiece Holder can be mounted to a vehicle dashboard at a location so that the driver can easily and safely reach the earpiece.

### SUMMARY OF INVENTION

The use of cellular telephones and other portable electronic devices is rapidly rising. Used in conjunction with these are various configurations of headset listening devices, usually comprising a single or pair of earpieces (ear buds) with connecting wiring. The convenient storage and safe usage of these earpieces has become an increasingly important issue. The Earpiece Holder, herein described addresses these issues.

### BRIEF DESCRIPTION OF DRAWINGS

FIG. 1 is an enlarged perspective view of the Earpiece Holder.

FIG. 2A is a view showing the direction of insertion of the earpiece into the holder.

FIG. 2B is a view showing the earpiece resting in the holder.

FIG. 3A is a front view of the Earpiece Holder.

FIG. 3B is a side view of the Earpiece Holder.

FIG. 3C is a top view of the Earpiece Holder.

### DETAILED DESCRIPTION

The Earpiece Holder is a flexible holder for earpieces that are used with cellular telephones, CD players and other audio devices. The product is designed so that it can be conveniently located in an vehicle so the driver or other user can easily and safely reach the earpiece. It can be mounted on the dashboard of an automobile in a location of the consumer's choice by means of a pressure sensitive adhesive on the back of the holder. By mounting the device in an appropriate location, the driver can reach the earpiece with a minimum of distraction. The Earpiece Holder can also be mounted in other locations of the vehicle for use by passengers to facilitate convenient and accessible storage of their personal headsets.

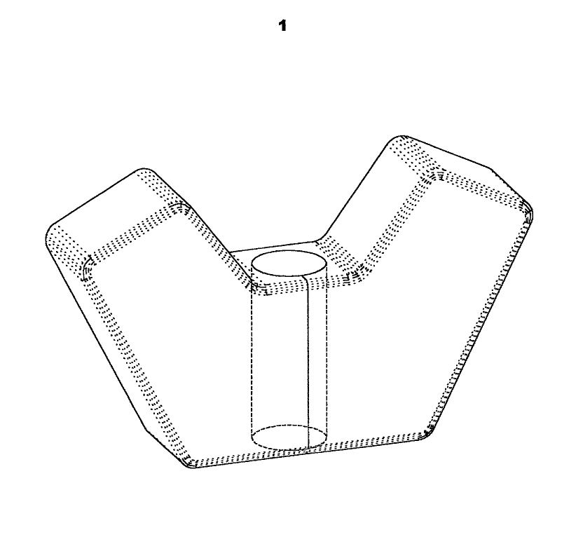

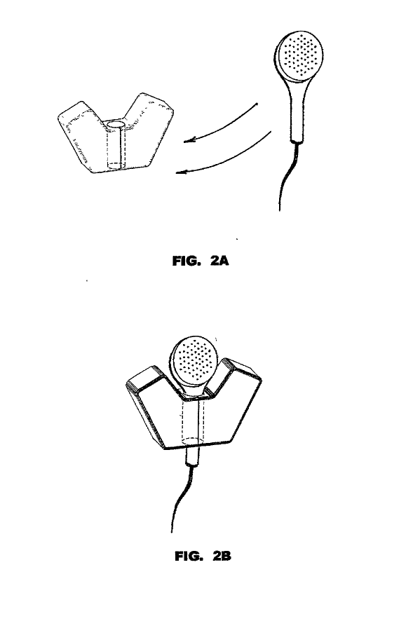

The Earpiece Holder, as shown in FIG. 1, is a one-piece device, molded with a vertical opening sized to accommodate the earpiece of the headset. There is a slit or separation vertically in the front of the device. The earpiece can easily be placed into the holder merely by pushing it into the slit as shown in FIG. 2A. Because the Earpiece Holder is a flexible material, the slit creates two flaps which bend, allowing the earpiece to be positioned into the vertical opening of the holder as shown in FIG. 2B. To remove the earpiece, the user just pulls it out of the holder.

The Earpiece Holder can be outfitted with a pressure sensitive adhesive so that it can be placed virtually anywhere by the end-use consumer, or it can be incorporated directly into an OEM part.

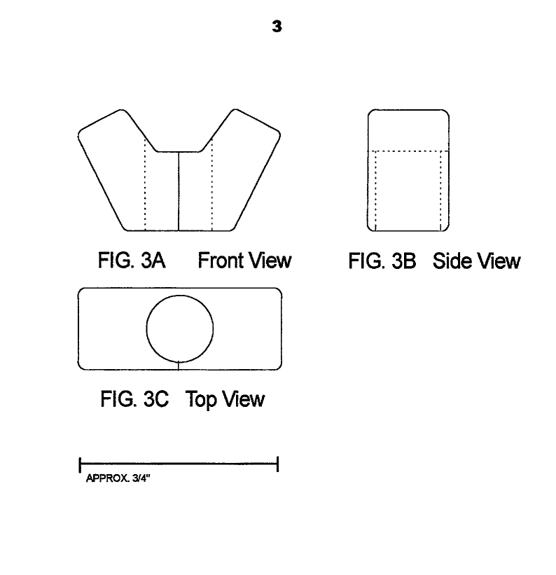

As indicated in FIG. 3A, 3B and 3C, the Earpiece Holder is about ¾ inches wide, ½ inches high and ⅜ inches deep. It is molded of a flexible material that allows the piece to flex at the vertical slit, thus allowing the earpiece to be easily placed and removed from the holder. With pressure sensitive adhesive at the back of the holder, it can be applied by the end-use consumer to a wide variety of surfaces.

1. What I claim as my invention is a holder for a corded earpiece for cellular telephones and other portable audio devices consisting of a flexible part incorporating an opening which acts as a receptacle for the earpiece and a slit in the holder that allows for easy placement and removal of the earpiece.
